(19) United States
(12) Patent Application Publication
(10) Pub. No.: US 2008/0117169 A1
(43) Pub. Date: May 22, 2008

(54) ENCODING MECHANISM WITH TILTABLE SCROLL WHEEL MODULE

(75) Inventor: Hsiao-Lung Chiang, Taipei (TW)

Correspondence Address: MADSON & AUSTIN, 15 WEST SOUTH TEMPLE, SUITE 900, SALT LAKE CITY, UT, 84101, US

(73) Assignee: Primax Electronics Ltd., Taipei (TW)

(21) Appl. No.: 11/624,025

(22) Filed: Jan. 17, 2007

(30) Foreign Application Priority Data
Nov. 17, 2006 (TW) 095142544

(51) Int. Cl. G09G 5/08

(52) U.S. Cl. 345/163

(57) ABSTRACT

An encoding mechanism with a tiltable scroll wheel module includes a scroll wheel, a wheel carrier and a multidirectional switch unit. The scroll wheel is operable by a user. The wheel carrier has a receptacle for receiving the scroll wheel therein such that the scroll wheel is rotatable in the receptacle. The wheel carrier further includes an indentation. The multidirectional switch unit includes a triggering button embedded into the indentation. By using the multidirectional switch to generate plural triggering signals, this encoding mechanism is simplified.

### FIELD OF THE INVENTION

The present invention relates to an encoding mechanism, and more particularly to an encoding mechanism with a tiltable scroll wheel module.

### BACKGROUND OF THE INVENTION

An input device such as a mouse or a keyboard has been widely employed in a computer system for scrolling images shown on the display screen upwardly and downwardly. For example, by rotating a scroll wheel of the input device forwardly or backwardly, a specified control signal is generated to control the scrolling operations of web pages. In addition to the vertical scroll movement, it is important to achieve the horizontal scroll movement. For example, since the texts or graphs shown in the graphic-based window of the display screen usually fail to be fully browsed, the horizontal scroll movement is required to move the web page or the document in the left or right direction so as to display the desired image as required.

For facilitating a user to perform the horizontal scroll movement of the web pages shown on the display screen by operating the scroll wheel, a tiltable scroll wheel module capable of being tilted leftwards or rightwards is developed. Such tiltable scroll wheel module is applicable to an input device such as a mouse or a keyboard. Referring to FIG. 1, a schematic outside view of a mouse having a tiltable scroll wheel module is illustrated. The tiltable scroll wheel module 11 of the mouse 1 is positioned within an opening 101 of the main body 10 of the mouse 1, and the scroll wheel 12 is partially protruded from the outer surface of the main body 10 such that the tiltable scroll wheel module 11 can be manipulated by a user. The scroll wheel 12 of the tiltable scroll wheel module 11 can be rotated forwardly (as shown in the arrow F) or backwardly (as shown in the arrow B) to generate a control signal, thereby scrolling the image shown on the display screen upwardly and downwardly. Furthermore, the scroll wheel 12 can be pressed down (as shown in the arrow D), tilted toward the left side (as shown in the arrow L) or tilted toward the right side (as shown in the arrow R) so as to generate three other control signals.

Referring to FIG. 2, a schematic perspective view of the tiltable scroll wheel module used in the tiltable scroll wheel module of FIG. 1 is illustrated. The tiltable scroll wheel module 11 principally comprises a scroll wheel 12, a rotating shaft 13, a carrier member 14 and a supporting member 15. The supporting member 15 has a receptacle 151 at the top side thereof. In addition, three switch units 16A, 16B and 16C are arranged under the bilateral sides of the carrier member 14 and under the rear end of the carrier member 14, respectively. The rotating shaft 13 is supported on a notch structure 141 of the carrier member 14, so that the scroll wheel 12 is rotatable along the rotating shaft 13.

Please refer to FIG. 2 again. The tiltable scroll wheel module 11 further comprises lateral wing structures 142A and 142B at bilateral sides of the carrier member 14 and above the switch units 16A and 16B, respectively. In addition, the front and rear ends of the carrier member 14 are formed as protrusion rods 143A and 143B. The protrusion rod 143A is movably supported on the receptacle 151 of the supporting member 15. Whereas, the protrusion rod 143B is placed on the top surface of the switch unit 16C. In a case that the scroll wheel 12 is tilted toward the left or right side, the receptacle 151 of the supporting member 15 and the top surface of the switch unit 16C are used as the fulcrum portions such that the carrier member 14 is movable in the left or right direction. Meanwhile, the lateral wing structure 142A or 142B will touch and trigger the switch unit 16A or 16B. In addition, in a case that the scroll wheel 12 is pressed down, the receptacle 151 of the supporting member 15 is served as the fulcrum portion such that the protrusion rod 143B is moved downwardly to trigger the switch unit 16C.

The tiltable scroll wheel module 11 mentioned above, however, still has some problems. For example, in the case that the scroll wheel 12 is not enabled, the protrusion rod 143B of the carrier member 14 is slightly in contact with the top surface of the switch unit 16C but the switch unit 16C is not triggered. If the scroll wheel 12 is pressed down, the switch unit 16C may be triggered by the protrusion rod 143B of the carrier member 14. Unfortunately, the depressing force applied onto the scroll wheel 12 is likely to improperly swing toward the left or right side due to a slippery hand or other reasons. Under this circumstance, the lateral wing structure 142A or 142B is likely to touch and trigger the switch unit 16A or 16B. As a consequence, the mouse 1 is suffered from an erroneous operation such as interruption of a current control signal or generation of an unanticipated control signal.

For solving the above problems, an input device with a tiltable scroll wheel module was disclosed in a co-pending Taiwanese Patent Application No. 95100875, which was filed by the same assignee of the present application on Jan. 10, 2006.

Referring to FIG. 3, a schematic perspective view of the tiltable scroll wheel module disclosed in Taiwanese Patent Application No. 95100875 is illustrated. In accordance with a feature of FIG. 3, the tiltable scroll wheel module 21 further includes two confining members 27 and 28 for confining the carrier member 24 in position. The confining members 27 and 28 have complementary shapes. Due to the complementary shapes, the confining member 27 is shifted downwardly to be engaged with the confining member 28 while the scroll wheel 22 is pressed down to trigger the switch unit 26C. Therefore, the carrier member 24 is confined in position so as to avoid improperly swinging the carrier member 24 toward the left or right side or otherwise allow for tiny swing of the carrier member 24. Under this circumstance, the carrier member 24 will no longer trigger the switch unit 26A or 26B while the scroll wheel 22 is pressed down to trigger the switch unit 26C. Until the depressing force applied onto the scroll wheel 22 is eliminated, the scroll wheel 22 is moved upwardly and returns to its original shape due to a restoring force generated from the compressed switch unit 26C. Meanwhile, the confining member 27 is disengaged from the confining member 28, so that the carrier member 24 can be tilted toward the left or right side as required.

The tiltable scroll wheel module 21 of FIG. 3 is effective for solving the problem occurred in the tiltable scroll wheel module 11 of FIG. 2. However, there are still some drawbacks. For example, since two switch units are arranged at the bilateral sides of the scroll wheel and associated triggering components are required to trigger these two switch units, the volume thereof occupies much working space within the mouse and is adverse to space utilization. In addition, too many components increase the assembling time of mounting the switch units and the triggering components onto the proper positions of the mouse.

Therefore, there is a need of providing an encoding mechanism with a simplified tiltable scroll wheel module.

### SUMMARY OF THE INVENTION

It is an object of the present invention to provide an encoding mechanism with a tiltable scroll wheel module by using a multidirectional switch unit, so that the encoding mechanism is simple in the structure and easily assembled.

In accordance with an aspect of the present invention, there is provided an encoding mechanism with a tiltable scroll wheel module. The encoding mechanism includes a scroll wheel, a wheel carrier and a multidirectional switch unit. The scroll wheel is operable by a user. The wheel carrier has a receptacle for receiving the scroll wheel therein such that the scroll wheel is rotatable in the receptacle. The wheel carrier further includes an indentation. The multidirectional switch unit includes a triggering button embedded into the indentation.

In an embodiment, a rotating shaft is protruded from bilateral sides of the scroll wheel.

In an embodiment, the wheel carrier further includes two sidewalls, two shaft support structures, a first wheel carrier axle and a second wheel carrier axle. The two sidewalls cooperatively define the receptacle for receiving the scroll wheel therein. The two shaft support structures are arranged on the two sidewalls for supporting the rotating shaft such that the scroll wheel is rotatable in the receptacle. The first wheel carrier axle is protruded from a first end of the wheel carrier. The second wheel carrier axle is protruded from a second end of the wheel carrier. The indentation is disposed in the second wheel carrier axle.

In an embodiment, the encoding mechanism further includes a support post, which has a notch for supporting the first wheel carrier axle therein.

Preferably, the multidirectional switch unit is a three-directional switch.

Preferably, the multidirectional switch unit is a five-directional switch.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic outside view of a mouse having a tiltable scroll wheel module according to prior art;

FIG. 2 is a schematic perspective view of the tiltable scroll wheel module of the mouse in FIG. 1;

FIG. 3 is a schematic perspective view of the tiltable scroll wheel module disclosed in Taiwanese Patent Application No. 95100875;

FIG. 4A is a schematic exploded view of an encoding mechanism with a tiltable scroll wheel module according to a preferred embodiment of the present invention;

FIG. 4B is a schematic exploded view of FIG. 4A taken from another viewpoint;

FIG. 5A is a schematic perspective view of a three-directional switch;

FIG. 5B is a schematic perspective view a five-directional switch; and

FIG. 6 is a schematic assembled view of the encoding mechanism of the present invention.

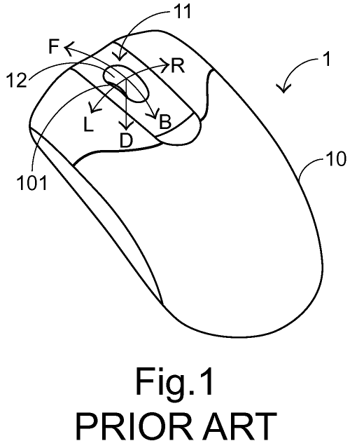

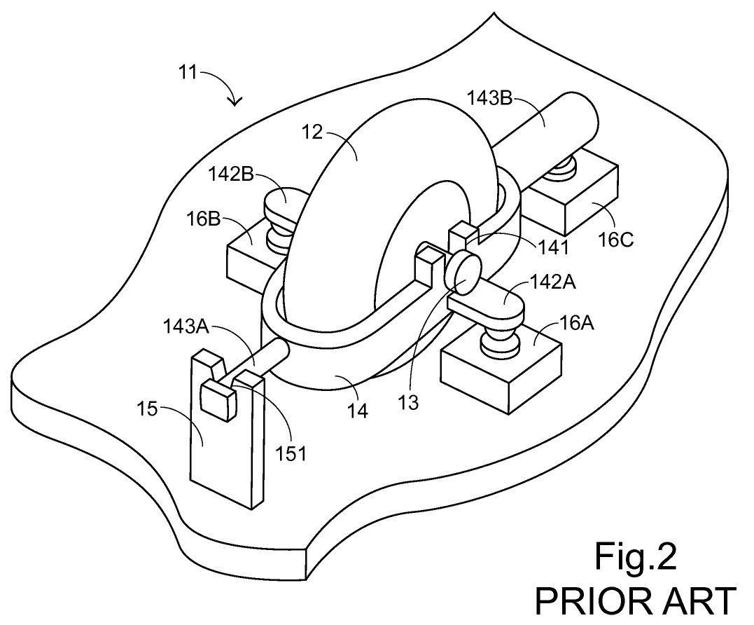

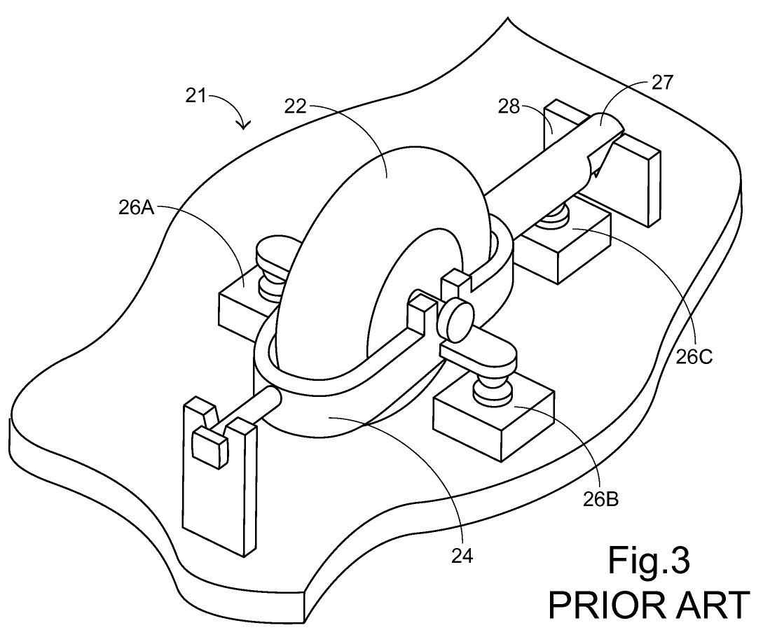

### DETAILED DESCRIPTION OF THE PREFERRED EMBODIMENT

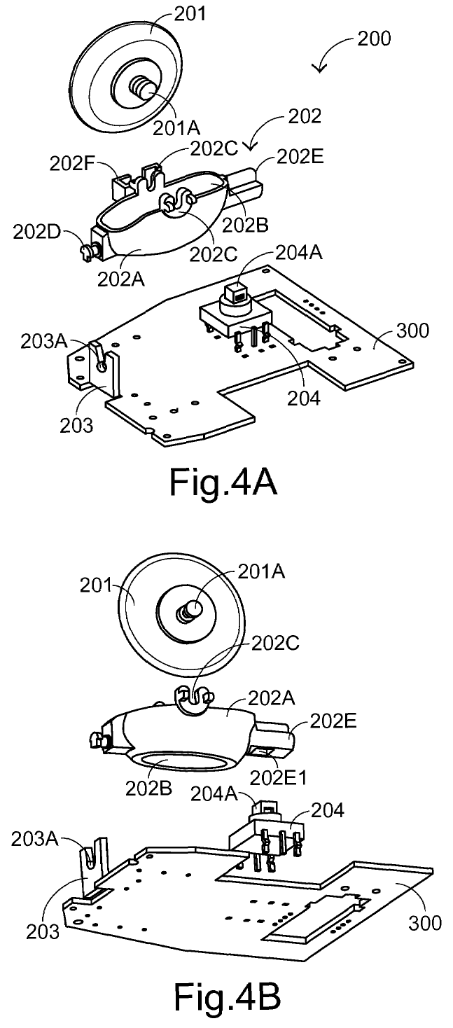

Referring to FIG. 4A, a schematic exploded view of an encoding mechanism with a tiltable scroll wheel module according to a preferred embodiment of the present invention is illustrated. Please also refer to FIG. 4B, which is a schematic exploded view of FIG. 4A taken from another viewpoint.

The encoding mechanism 200 with a tiltable scroll wheel module includes a scroll wheel 201, a wheel carrier 202, a support post 203 and a multidirectional switch unit 204. A rotating shaft 201A is protruded from bilateral sides of the scroll wheel 201. The wheel carrier 202 includes two sidewalls 202A, a receptacle 202B, two shaft support structures 202C, a first wheel carrier axle 202D and a second wheel carrier axle 202E. The shaft support structures 202C are arranged on the two sidewalls 202A, respectively. The first wheel carrier axle 202D is protruded from a first end of the wheel carrier 202. The second wheel carrier axle 202E is protruded from a second end of the wheel carrier 202. The second wheel carrier axle 202E includes an indentation 202E1. The support post 203 includes a notch 203A. The multidirectional switch unit 204 is disposed under the second wheel carrier axle 202E and includes a triggering button 204A.

Moreover, the encoding mechanism 200 may be mounted on a circuit board 300 and arranged within a mouse main body. An encoding receiving structure 202F is extended from a sidewall 202A of the wheel carrier 202 for accommodating a mechanical encoder (not shown) therein.

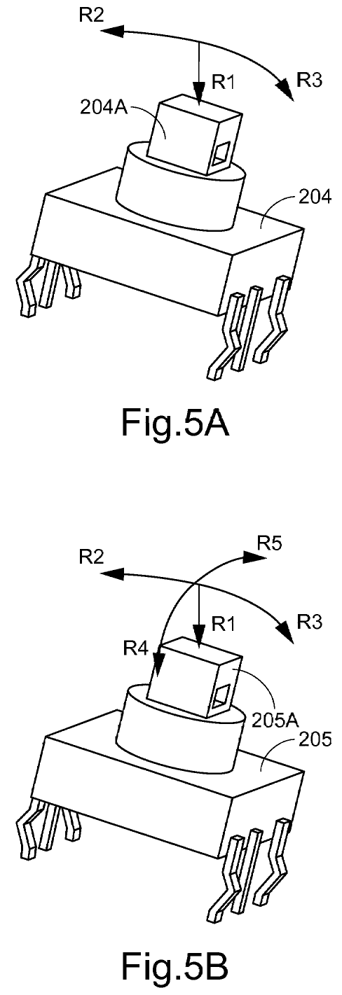

Referring to FIGS. 5A and 5B, two examples of the multidirectional switch unit are schematically illustrated. In FIG. 5A, the multidirectional switch unit 204 is a three-directional switch. In FIG. 5B, the multidirectional switch unit 205 a five-directional switch. As shown in FIG. 5A, three triggering signals are generated when the triggering button 204A of the three-directional switch 204 is triggered. That is, in response to external forces as shown in the arrows R1, R2 and R3, first, second and third triggering signals are respectively generated. Until the external force applied onto the triggering button 204A is eliminated, the triggering button 204A returns to its original position. As previously described, the conventional switch unit is triggered to generate a triggering signal. In contrast, a single three-directional switch 204 can be triggered to generate three triggering signals. Likewise, as shown in FIG. 5B, five triggering signals are generated when the triggering button 205A of the five-directional switch 205 is triggered. That is, in response to external forces as shown in the arrows R1, R2, R3, R4 and R5, five triggering signals are respectively generated.

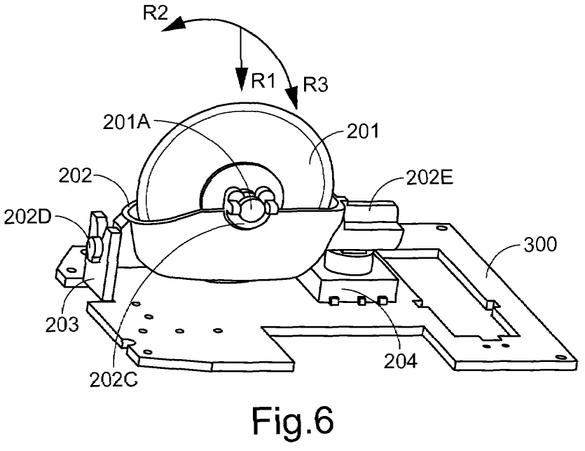

Referring to FIG. 6, a schematic assembled view of the encoding mechanism shown in FIGS. 4A and 4B is illustrated. Hereinafter, the structure and the operations of the encoding mechanism will be illustrated with reference to FIG. 6, FIG. 4A and FIG. 4B.

First of all, the scroll wheel 201 is partially received within the receptacle 202B between the two sidewalls 202A. Then, both ends of the rotating shaft 201A are received in the shaft support structures 202C of the wheel carrier 202 such that the scroll wheel 201 is rotatably mounted on the wheel carrier 202. The first wheel carrier axle 202D of the wheel carrier 202 is supported within the notch 203A of the support post 203. The second wheel carrier axle 202E is arranged above the multidirectional switch unit 204. The triggering button 204A of the multidirectional switch unit 204 is embedded into the indentation 202E1 of the second wheel carrier axle 202E. In addition, the multidirectional switch unit 204 is mounted on the circuit board 300.

The encoding mechanism 200 may be disposed within a mouse main body (not shown), and a portion of the scroll wheel 201 is protruded from the outer surface of the main body such that the scroll wheel 201 can be manipulated by a user.

When the scroll wheel 201 is rotated, the mechanical encoder within the encoding receiving structure 202F will generate a third axle signal to control image scrolling. When the scroll wheel 201 is pressed down to have the wheel carrier 202 move downwardly, the second wheel carrier axle 202E of the wheel carrier 202 will touch the triggering button 204A of the three-directional switch 204. Meanwhile, the triggering button 204A is triggered in response to the external force along the direction R1, thereby generating the fist triggering signal. When the scroll wheel 201 is tilted toward the left side in the direction R2, the triggering button 204A is also tilted toward the left side in the direction R2 to generate the second triggering signal because the triggering button 204A of the multidirectional switch unit 204 is embedded into the indentation 202E1 of the second wheel carrier axle 202E. Similarly, when the scroll wheel 201 is tilted toward the right side in the direction R3, the triggering button 204A is also tilted toward the right side in the direction R3 to generate the third triggering signal.

Likewise, by operating the scroll wheel 201, five triggering signals are generated when the triggering button 205A of the five-directional switch 205 is triggered.

From the above description, the tiltable scroll wheel module of the encoding mechanism according to the present invention has functions similar to the conventional tiltable scroll wheel module by using a single multidirectional switch unit. Moreover, the problems of using three switch units will be solved so as to avoid an erroneous operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An encoding mechanism with a tiltable scroll wheel module, said encoding mechanism comprising:
a scroll wheel operable by a user;
a wheel carrier having a receptacle for receiving said scroll wheel therein such that said scroll wheel is rotatable in said receptacle, wherein said wheel carrier further includes an indentation; and
a multidirectional switch unit including a triggering button embedded into said indentation.

2. The encoding mechanism according to claim 1 wherein a rotating shaft is protruded from bilateral sides of said scroll wheel.

3. The encoding mechanism according to claim 2 wherein said wheel carrier further includes:
two sidewalls cooperatively defining said receptacle for receiving said scroll wheel therein;
two shaft support structures arranged on said two sidewalls for supporting said rotating shaft such that said scroll wheel is rotatable in said receptacle;
a first wheel carrier axle protruded from a first end of said wheel carrier; and
a second wheel carrier axle protruded from a second end of said wheel carrier, wherein said indentation is disposed in said second wheel carrier axle.

4. The encoding mechanism according to claim 1 further including a support post, which has a notch for supporting said first wheel carrier axle therein.

5. The encoding mechanism according to claim 1 wherein said multidirectional switch unit is a three-directional switch.

6. The encoding mechanism according to claim 1 wherein said multidirectional switch unit is a five-directional switch.
